(19) United States
(12) Patent Application Publication
(10) Pub. No.: US 2009/0222199 A1
(43) Pub. Date: Sep. 3, 2009

(54) Navigation device and navigation program

(75) Inventor: Takuya Nishiura, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/320,563

(22) Filed: Jan. 29, 2009

(30) Foreign Application Priority Data
Feb. 28, 2008 (JP) 2008-047581

(51) Int. Cl. G01C 21/36

(52) U.S. Cl. 701/201

(57) ABSTRACT

Navigation devices, methods, and programs display a list of facilities without calculating an estimated travel time from the current position of the vehicle to a facility position by displaying the facilities in the order of a front-left side area, a front-right side area, a rear-left side area, a the rear-right side area, with the searched facilities in each area being displayed in the order of distance from the vehicle. Alternatively or additionally, the devices, methods, and programs display the list by: calculating an estimated travel time from the current position of the vehicle to a facility position only for the searched facilities assigned to a medium distance area; and displaying the facilities in the order of a short distance area, the medium distance area, and a long distance area, with the searched facilities in the short distance area and the long distance area being displayed in the order of distance from the vehicle and the searched facilities in the medium distance area being displayed in the order of the shortest estimated travel time.

### INCORPORATION BY REFERENCE

The disclosure of Japanese Patent Application No. 2008-047581, filed on Feb. 28, 2008, including the specification, drawings and abstract thereof, is incorporated herein by reference in its entirety.

### BACKGROUND

1. Related Technical Fields

Related technical fields include navigation devices and navigation programs that search for facilities in a vicinity area and perform guidance to the searched facilities.

2. Related Art

To search for facilities in the vicinity of a current position, a method is known in which a list of facilities is displayed by calculating a direct distance to each of the searched facilities and sorting the searched facilities in the order of the distance from the current position. However, in this method, there are cases in which a facility that is sorted as being the shortest distance from a current position is not the facility that can be reached in the shortest amount of time when traveled by a vehicle. Another method is known in which when facilities belonging to a user-designated category are searched and narrowed by the vicinity of the current position, a list is displayed, not in the order of the distance from the current position, but in the order of the shortest travel distance or the shortest estimated travel time. This is accomplished by performing a route search toward an individual facility calculating the travel distance or the estimated travel time to each facility (refer to Japanese Unexamined Patent Application Publication No. 2003-232641).

### SUMMARY

In the method of Japanese Unexamined Patent Application Publication No. 2003-232641, if there are numerous corresponding facilities, the searching time increases and the central processing unit load of a navigation device becomes burdensome because a route search is performed toward all the corresponding facilities.

Various exemplary implementations of the broad inventive principles described herein reduce the processing load on the navigation device and to make it possible to quickly display the facility list in the order of the shortest travel distance or the shortest estimated travel time, when facilities in a vicinity area are searched and displayed in a list.

Various exemplary implementations provide devices, methods, and programs that detect a current position of a vehicle, store map information including facility data, set an area within a specified range from the current position of the vehicle as the vicinity area, and search for facilities in the vicinity area. The devices, methods, and programs may display, for example, when the vehicle is on a road, the list without calculating an estimated travel time from the current position of the vehicle to a facility position by (1) dividing the vicinity area into a front-left side area, a front-right side area, a rear-left side area, and a rear-right side area in relation to the vehicle and assigning each of the searched facilities to one of the front-left side area, the front-right side area, the rear-left side area, and the rear-right side area; and (2) displaying the facilities in the order of the front-left side area, the front-right side area, the rear-left side area, and the rear-right side area, with the searched facilities in each area being displayed in the order of distance from the vehicle.

Alternatively or additionally, the devices, methods, and programs may display, for example, when the vehicle is not on a road, the list by: (1) dividing the vicinity area into a short distance area, a medium distance area, and a long distance area in relation to the vehicle and assigning each of the searched facilities to one of the short distance area, the medium distance area and the long distance area; (2) calculating an estimated travel time from the current position of the vehicle to a facility position only for the searched facilities assigned to the medium distance area; and (3) displaying the facilities in the order of the short distance area, the medium distance area and the long distance area, with the searched facilities in the short distance area and the long distance area being displayed in the order of distance from the vehicle and the searched facilities in the medium distance area being displayed in the order of the shortest estimated travel time.

### BRIEF DESCRIPTION OF THE DRAWINGS

FIG. 1 is a block diagram showing an exemplary configuration of a navigation device;

FIGS. 2A and 2B show an example of listing facilities obtained by a vicinity search; and

FIGS. 3A and 3B show another example of listing facilities obtained by the vicinity search.

### DETAILED DESCRIPTION OF EXEMPLARY IMPLEMENTATIONS

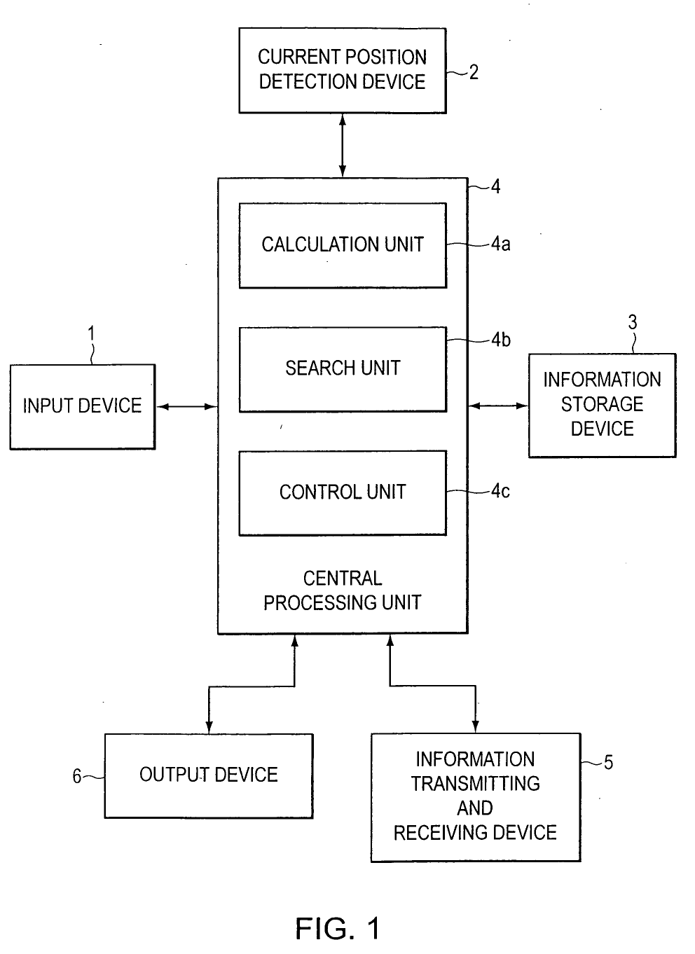

Hereinafter, an exemplary navigation device will be described in detail. FIG. 1 is a diagram showing an exemplary configuration of a navigation device. The navigation device includes an input device 1, a current position detection device 2, an information storage device 3, a controller (e.g., central processing unit 4), an information transmitting and receiving device 5, and an output device 6. The input device 1 includes a keyboard, a mouse, a touch panel, an operation key, and the like to input information, such as a category and the like, that are used in a search for a departure point, a destination, and facilities in a vicinity area. The current position detection device 2 detects information regarding the current position of a vehicle. The information storage device 3 stores map data, road data, intersection data, facility data of various categories, navigation data necessary for a route search, display/voice guidance data necessary for route guidance, and a program (an application and/or an operating system) that performs a map display, a route search, and guidance such as voice guidance and the like.

The central processing unit 4 includes: a calculation unit 4a that calculates an estimated travel time from the current position of the vehicle to a facility position; a search unit 4b that sets an area within a specified range from the current position of the vehicle as the vicinity area and searches facilities in the vicinity area; and a control unit 4c that, to display the searched facilities in a list, divides the vicinity area into plural areas, sorts the facilities in each of the divided areas in the order of distance, sorts the facilities in a specific area in the order of estimated travel time, and further prioritizes the divided areas and sorts the facilities. The central processing unit 4 performs, as a navigator processing unit, map display processing, route search processing, and display/voice guidance processing necessary for route guidance, in addition to a control of an overall system. The information transmitting and receiving device 5 transmits and receives information regarding vehicle driving, for example, road information and traffic information, detects information regarding the current position of the vehicle, and further transmits and receives information regarding the current position. The output device 6 includes a display, a speaker, and other output devices for outputting information regarding facilities listed by the vicinity search and route guidance.

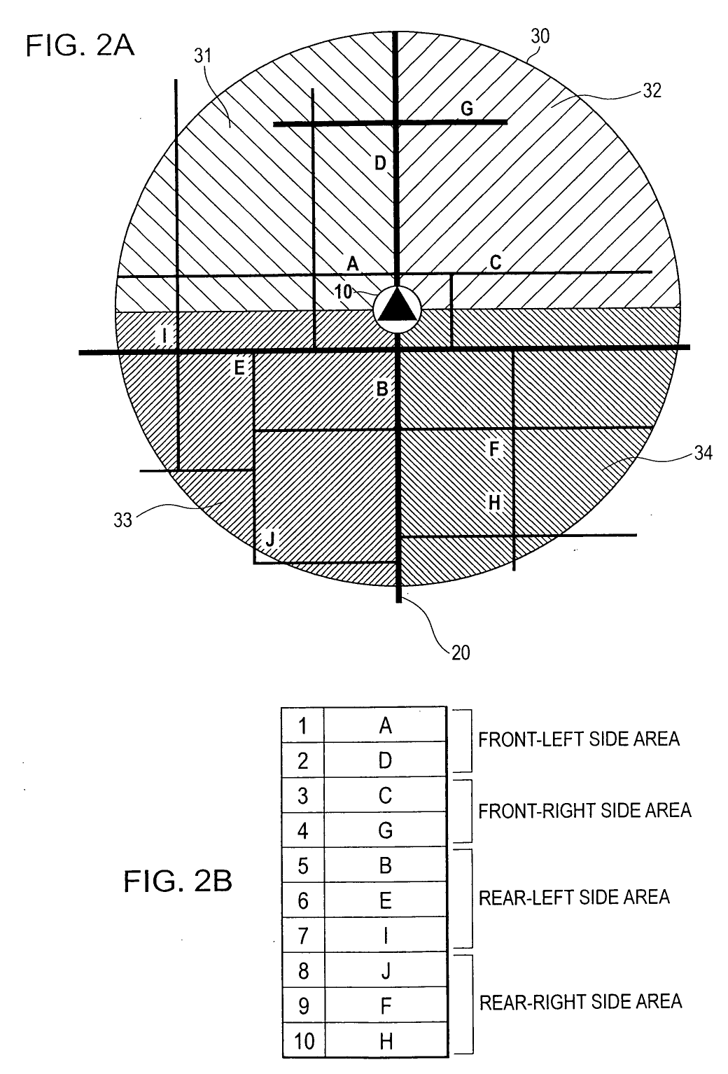

FIGS. 2A and 2B show an example of guidance by listing and displaying facilities obtained by the vicinity search. FIG. 2A is a drawing that explains a sorting method of searched facilities. FIG. 2B shows a facility list to be displayed.

FIG. 2A represents a situation in which a vehicle 10 travels on a road 20 upward in the drawing. In this situation, the vicinity search is performed at the position shown in the drawing by the navigation device installed in the vehicle, and a range 30 is the vicinity area to search that is centered on the vehicle. A small area for the vicinity search is set when there are a large number of facilities of various categories, such as public facilities, convenience stores, restaurants, gas stations, and the like. However, when there are a small number of facilities, a large area for the vicinity search is set. In performing a search, designating a category is optional. In the example set forth in FIGS. 2A and 2B, symbols A to H indicate the searched facilities and are assigned in the order of the shortest direct distance from the vehicle. If the facilities are displayed in the list in the order of the shortest direct distance from the vehicle, there are cases in which the facility searched as being at the shortest distance is not the facility that can be reached by vehicle in the shortest amount of time. For this reason, conventionally, guidance has been performed by performing route searches toward the facilities A to H, calculating estimated travel times to the respective facilities, and displaying the list in the order of the shortest estimated travel time. However, this method requires time to provide guidance and increases the processing load on the navigation device installed in the vehicle.

In the example shown in FIGS. 2A and 2B, the searched facilities are displayed in the list substantially in the order of the shortest estimated travel time, without performing a route search. To this end, the vicinity area 30 is divided into quadrants, specifically: a front-left side area 31, a front-right side area 32, a rear-left side area 33, and a rear-right side area 34, in relation to the vehicle 10. The searched facilities in each quadrant are sorted in the order of direct distance from the vehicle. For example, the facilities A to H are sorted in the orders of A, D for the front-left side area 31, C, G for the front-right side area 32, B, E, I, and J for the rear-left side area 33, and F, H for the rear-right side area 34. The facilities in the same area can be reached under almost the same conditions.

Therefore, a result acquired by sorting the facilities in the order of the shortest direct distance is almost the same as a result acquired by sorting the facilities in the order of the shortest estimated travel time. For example, in left-hand traffic, it is generally easier and quicker to reach a destination facility in the left area than in the right area because a facility in the left area requires a left turn while a facility in the right area requires a generally slower right turn. Similarly, it is generally easier and quicker to reach a destination facility in the front area than in the back area because a facility in the front area requires forward linear travel as opposed to the generally slower backward travel required by a facility in the rear area.

Hence, the facilities in the front area are sorted in the order of the front-left side area 31, the front-right side area 32. As for the rear area, it normally takes less time to go backward through a left turn; therefore, the rear-left side area 33 can be reached earlier than the rear-right side area 34. Hence, the facilities in the rear area are sorted in the order of the rear-left side area 33, the rear-right side area 34. The facilities in the same area are sorted in the order of direct distance from the vehicle. Further, the facilities are sorted in the order of the front-left side area, the front-right side area, the rear-left side area, and the rear-right side area in relation to the vehicle. That is, in this example, the facilities are sorted in the order of A, D, C, G, B, E, I, J, F, and H, and the list is displayed (refer to FIG. 2B). In this way, the facilities can be listed substantially in the order of the shortest travel time without performing a route search and displayed on a guidance screen. Note that the vicinity area is preferably divided into the right side area and left side area of the vehicle, using the road traveled by the vehicle as a reference. When the vehicle is not on a road, for example, when the vehicle is parked in a parking area or a service area that is along the road, the vicinity area may be divided into the right side area, the left side area or the like using the road as a reference. Note that in the case of a right-hand traffic, the right and the left are inverted.

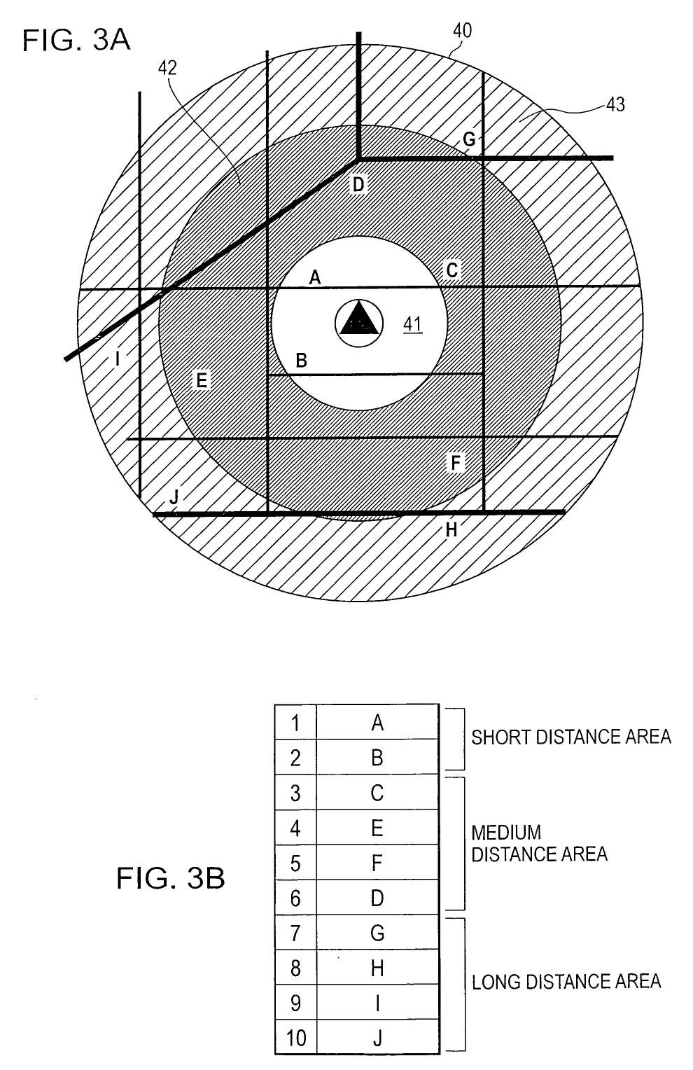

FIGS. 3A and 3B show another example of listing the facilities obtained by the vicinity search. FIG. 3A is a drawing that explains a sorting method of searched facilities. FIG. 3B shows a facility list to be displayed.

FIG. 3A represents a situation in which the vicinity search is performed when the vehicle 10 is not on a road, for example, parked in a facility like a parking lot, and a range 40 is the vicinity area to search that is centered on the vehicle. Symbols A to H in FIGS. 3A and 3B indicate the searched facilities, and are assigned in the order of the shortest direct distance from the vehicle; however, if a list is displayed in this order, there are cases in which the facility searched as being at the shortest distance is not the facility that can be reached in the shortest time, and if route searches are performed to all the facilities, the processing load increases. In this example, by dividing the vicinity area into plural sections and performing route searches only toward the facilities in a part of the sections, the processing load is reduced and the list can be displayed substantially in the order of the shortest estimated travel time of the vehicle.

Because the vehicle is parked, the same conditions exist for any direction in which the vehicle subsequently travels, and therefore the vicinity area to be searched is divided by distance into a short distance area 41, a medium distance area 42, and a long distance area 43, and the facilities are sorted in the order of the shortest distance. The facilities in the short and long distance areas are sorted in the order of the shortest direct distance because for a place very close to the vehicle, such as the short distance area, it does not make much difference in the travel time even if route searches are performed; and for a place very far from the vehicle such as the long distance area, the processing load of route searches is heavy. For the medium distance area 42, after performing route searches, the facilities are sorted in the order of the shortest estimated travel time. Thus, the facilities in the short and long distance areas are sorted in the order of the shortest direct distance, while the facilities in the medium distance area are sorted in the order of the shortest estimated travel time after route searches. Then, the facilities are sorted in the order of the short distance area, the medium distance area, and the long distance area.

In the case of the example set forth in FIGS. 3A and 3B, the list is displayed in the order of A, B, C, E, F, D, G, H, I, and J (refer to FIG. 3B). Thus, the processing load on the navigation device is reduced and the list can be displayed in the order of the shortest travel time. The above described situation is a case in which a vehicle is parked in a parking lot; however, the example of listing the facilities obtained by the vicinity search of FIGS. 3A and 3B is also applicable to cases in which a vehicle can move in any direction under the same conditions, even on a road.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying inventive principles.

What is claimed is:

1. A navigation device that searches for facilities in a vicinity area and displays a result of the search in a list, comprising:
a current position detector that detects a current position of a vehicle;
an information storage unit that stores map information including facility data; and
a controller that:
sets an area within a specified range from the current position of the vehicle as the vicinity area and searches for facilities in the vicinity area;
when the vehicle is on a road, displays the list without calculating an estimated travel time from the current position of the vehicle to a facility position by:
dividing the vicinity area into a front-left side area, a front-right side area, a rear-left side area, and a rear-right side area in relation to the vehicle and assigning each of the searched facilities to one of the front-left side area, the front-right side area, the rear-left side area, and the rear-right side area; and
displaying the facilities in the order of the front-left side area, the front-right side area, the rear-left side area, and the rear-right side area, with the searched facilities in each area being displayed in the order of distance from the vehicle; and
when the vehicle is not on a road, displays the list by:
dividing the vicinity area into a short distance area, a medium distance area, and a long distance area in relation to the vehicle and assigning each of the searched facilities to one of the short distance area, the medium distance area, and the long distance area;
calculating an estimated travel time from the current position of the vehicle to a facility position only for the searched facilities assigned to the medium distance area; and
displaying the facilities in the order of the short distance area, the medium distance area, and the long distance area, with the searched facilities in the short distance area and the long distance area being displayed in the order of distance from the vehicle and the searched facilities in the medium distance area being displayed in the order of the shortest estimated travel time.

2. The navigation device of claim 1, wherein the vehicle is not on a road when the vehicle is in a parking lot.

3. A navigation device that searches for facilities in a vicinity area and displays a result of the search in a list, comprising:
a current position detector that detects a current position of a vehicle;
an information storage unit that stores map information including facility data; and
a controller that:
sets an area within a specified range from the current position of the vehicle as the vicinity area and searches for facilities in the vicinity area; and
displays the list without calculating an estimated travel time from the current position of the vehicle to a facility position by:
dividing the vicinity area into a front-left side area, a front-right side area, a rear-left side area, and a rear-right side area in relation to the vehicle and assigning each of the searched facilities to one of the front-left side area, the front-right side area, the rear-left side area, and the rear-right side area; and
displaying the facilities in the order of the front-left side area, the front-right side area, the rear-left side area, and the rear-right side area, with the searched facilities in each area being displayed in the order of distance from the vehicle.

4. A navigation device that searches for facilities in a vicinity area and displays a result in a list, comprising:
a current position detector that detects a current position of a vehicle;
an information storage unit that stores map information including facility data; and
a controller that:
sets an area within a specified range from the current position of the vehicle as the vicinity area and searches for facilities in the vicinity area;
displays the list by:
dividing the vicinity area into a short distance area, a medium distance area, and a long distance area in relation to the vehicle and assigning each of the searched facilities to one of the short distance area, the medium distance area, and the long distance area;
calculating an estimated travel time from the current position of the vehicle to a facility position only for the searched facilities assigned to the medium distance area; and
displaying the facilities in the order of the short distance area, the medium distance area, and the long distance area, with the searched facilities in the short distance area and the long distance area being displayed in the order of distance from the vehicle and the searched facilities in the medium distance area being displayed in the order of the shortest estimated travel time.

5. A computer-readable storage medium storing a computer-executable program usable to control a navigation device that searches for facilities in a vicinity area and displays a result of the search in a list, the program comprising:
instructions for detecting a current position of a vehicle;
instructions for storing map information including facility data; and
instructions for setting an area within a specified range from the current position of the vehicle as the vicinity area and searches for facilities in the vicinity area;
instructions for displaying, when the vehicle is on a road, the list without calculating an estimated travel time from the current position of the vehicle to a facility position by:
dividing the vicinity area into a front-left side area, a front-right side area, a rear-left side area, and a rear-right side area in relation to the vehicle and assigning each of the searched facilities to one of the front-left side area, the front-right side area, the rear-left side area, and the rear-right side area; and
displaying the facilities in the order of the front-left side area, the front-right side area, the rear-left side area, and the rear-right side area, with the searched facilities in each area being displayed in the order of distance from the vehicle; and
instructions for displaying, when the vehicle is not on a road, the list by:
dividing the vicinity area into a short distance area, a medium distance area, and a long distance area in relation to the vehicle and assigning each of the searched facilities to one of the short distance area, the medium distance area, and the long distance area;
calculating an estimated travel time from the current position of the vehicle to a facility position only for the searched facilities assigned to the medium distance area; and
displaying the facilities in the order of the short distance area, the medium distance area, and the long distance area, with the searched facilities in the short distance area and the long distance area being displayed in the order of distance from the vehicle and the searched facilities in the medium distance area being displayed in the order of the shortest estimated travel time.
